(19) United States
(12) Patent Application Publication
(10) Pub. No.: US 2016/0350740 A1
(43) Pub. Date: Dec. 1, 2016

(54) METHOD FOR DISTRIBUTING REVENUE DATA

(71) Applicant: Beijing Jinher Software Co., Ltd., Beijing (CN)

(72) Inventor: Runfeng LUAN, Beijing (CN)

(21) Appl. No.: 14/738,939

(22) Filed: Jun. 15, 2015

(30) Foreign Application Priority Data
May 29, 2015 (CN) 201510289266.7

(51) Int. Cl. G06Q 20/22; G06Q 30/06

(52) U.S. Cl. CPC G06Q 20/22; G06Q 30/0601

(57) ABSTRACT

The present invention discloses method for distributing revenue data, including: finding a place in real life for exhibiting a real article, and taking a master of the place as a first revenue receiving party; wherein, the real article is exhibited by a display cabinet having a two-dimensional code thereon which is associated with the first revenue receiving party, an electronic business service platform of the real article is accessible by a user terminal scanning the two-dimensional code, the electronic business service platform is presented with introduction and a purchase interface for the real article, and an operator of the electronic business service platform is taken as a second revenue receiving party; wherein, revenue data from the purchased real article is distributed to the first revenue receiving party and the second revenue receiving party.

### CROSS-REFERENCE TO RELATED APPLICATION

This application claims the priority benefit of Chinese patent application No. 201510289266.7, filed May 29, 2015. The entirety of the above-mentioned patent application is hereby incorporated by reference herein and made a part of specification.

### TECHNICAL FIELD

The present invention relates to the technical field of E-commerce, and more particularly, to a method for distributing revenue data.

### BACKGROUND

With the technology of Internet and E-commerce getting mature, more and more people tend to shop through network, and many merchants and manufacturers also actively join the network marketing business, pushing a proportion of network purchase in social purchase increasingly higher. However, on a network platform, only pictures of goods may be accessed, not the real articles, resulting in a gap of expectation after the goods is bought home. Moreover, shopping merely at home through the network platforms kills the fun of shopping in real life.

Different from a two-dimensional picture seen on a network platform, by shopping in a mall, a consumer may see a real article, and get better information of the size and quality of the article. However, different from shopping through network, when shopping in a mall, the consumer needs to get in line before a cashier. It may be time-consuming when the line is too long, which wastes precious time of the consumer. Moreover, the consumer needs to carry the purchased article with him or her, which is troublesome for subsequent shopping.

If there is a method, which may combine the shopping online and shopping in real life, gather the consumer, a master of a place and a supplier of a commodity at an electronic business platform, allow the consumer to shop anywhere in a shopping place, a bus stop, a subway station or a community by directly purchasing a desired commodity and help himself/herself to pay without a cashier according a rule and a process on an electronic business platform as soon as he or she sees the commodity, directly mail the purchased commodity to a place designated by the consumer, and moreover, distribute the revenue among merchants on the platform, a selling process may be simplified for the suppliers, intermediate logistics among suppliers may be saved, selling order may be ensured, selling cost may be lowered, and the consumer may be not only offered with preferential prices and commodities with excellent qualities, but also experience the fun of shopping in real life.

### SUMMARY

One objective of the present invention is to overcome at least the above issues and defects, and to provide at least advantages given below.

Another objective of the present invention is to provide a method for distributing revenue data, through which a user may access a designated electronic business service platform to shop by himself/herself through scanning a two-dimensional code of an article exhibited in a community, a shopping mall or a subway, and afterwards the selected article may be mailed home.

Another objective of the present invention is to allow a user to acquire an electronic business service platform where a commodity is presented by scanning a two-dimensional code, and to allow the electronic business service platform to associate the user terminal with a master of a place where the commodity is located, thereby facilitating a direct distribution of a part of revenue data to a first revenue receiving party after the commodity is directly bought by the user.

In order to achieve these objectives and other advantages, a method for distributing revenue data is provided, comprising:

finding a place in real life for exhibiting a real article, and taking a master of the place as a first revenue receiving party;

wherein, the real article is exhibited by a display cabinet having a two-dimensional code thereon which is associated with the first revenue receiving party, an electronic business service platform of the real article is accessible by a user terminal scanning the two-dimensional code, the electronic business service platform is presented with introduction and a purchase interface for the real article, and an operator of the electronic business service platform is taken as a second revenue receiving party;

wherein, revenue data from the purchased real article is distributed to the first revenue receiving party and the second revenue receiving party.

Preferably, the display cabinet is an unattended cabinet which is not freely opened.

Preferably, the real article is the article itself which is to be sold, a model of the article to be sold, an imitation of the article to be sold, or a promotion article of a business service.

Preferably, the method further comprises: recording a MAC code of the user terminal to associate the user terminal with the first revenue receiving party, and distributing each revenue data from a real article subsequently purchased by the user terminal through the electronic business service platform to the first revenue receiving party.

The objectives of the present invention may further implemented by a method for distributing revenue data, including:

finding a place in real life for exhibiting a real article, and taking a master of the place as a first revenue receiving party;

wherein, the real article is exhibited by a display cabinet having a two-dimensional code thereon, address information of a place where a user terminal is located is collected by the user terminal scanning the two-dimensional code, a master of the place is determined through the address information, to associated the user terminal and the first revenue receiving party, then an electronic business server of the real article is accessible by the user terminal scanning the two-dimensional code, the electronic business server is presented with introduction and a purchase interface for the real article, and an operator of the electronic business server is taken as a second revenue receiving party;

wherein, revenue data from the purchased real article is distributed to the first revenue receiving party and the second revenue receiving party.

Preferably, associating the user terminal and the first revenue receiving party comprises: recording a MAC code of the user terminal to associated the MAC code of the user terminal with the first revenue receiving party, and distributing each revenue data from a real article subsequently purchased by the user terminal through the electronic business service platform to the first revenue receiving party.

Preferably, the method further comprises: taking a storekeeper on the electronic business service platform as a third revenue receiving party, wherein, revenue data from the purchased real article is distributed to the first revenue receiving party, the second revenue receiving party and the third revenue receiving party.

The objectives of the present invention may further implemented by a method for distributing revenue data, including:

finding a place in real life for exhibiting a real article, and taking a master of the place as a first revenue receiving party, and the first revenue receiving party having an identifier ID;

wherein, the real article is exhibited by a display cabinet having a two-dimensional code thereon, a user terminal is associated with the first revenue receiving party by the user terminal scanning the identifier ID, and an electronic business server of the real article is accessible by the user terminal scanning the two-dimensional code, the electronic business server is presented with introduction and a purchase interface for the real article, and an operator of the electronic business server is taken as a second revenue receiving party;

wherein, revenue data from the purchased real article is distributed to the first revenue receiving party and the second revenue receiving party.

Preferably, associating the user terminal and the first revenue receiving party comprises: recording a MAC code of the user terminal to associated the MAC code of the user terminal with the first revenue receiving party, and distributing each revenue data from a real article subsequently purchased by the user terminal through the electronic business service platform to the first revenue receiving party.

Preferably, the real article is locked inside the display cabinet, and the real article is fully presented in a virtual form after a two-dimensional code corresponding to the real article is scanned.

Preferably, the place comprises a bus stop, a lobby of a building, an entrance of a restaurant, a shopping mall or a subway channel.

Preferably, the method further comprises: taking a storekeeper on the electronic business service platform as a third revenue receiving party, wherein, revenue data from the purchased real article is distributed to the first revenue receiving party, the second revenue receiving party and the third revenue receiving party.

Preferably, the virtual form comprises: a video, a full-view picture or a picture accompanied by a text.

Preferably, the real article comprises a service.

The present invention at least includes the following advantageous effects: it combines the shopping online and shopping in real life, saves time, and allows consumers to experience the fun of shopping in a real place. The real place may be a bus stop, a bus stop, a lobby of a building, an entrance of a restaurant, a shopping mall or a subway channel, which are all high traffic places, and also places people go through every day, thus traffic time of shopping may be saved. Compared with shopping online where only pictures or videos may be seen, in this shopping manner, real articles, models of articles, or imitation of articles may be actually seen in vivid. After an article is purchased, it may be directly delivered from a warehouse to the consumer's home, saving costs of oil for shipping the goods to a shopping mall, thereby reducing the cost.

### BRIEF DESCRIPTION OF THE DRAWINGS

FIG. 1 is a flow chart showing a method for distributing revenue data in a first embodiment;

FIG. 2 is a flow chart showing a method for distributing revenue data in a second embodiment; and

FIG. 3 is a flow chart showing a method for distributing revenue data in a third embodiment.

### DETAILED DESCRIPTION

Hereinafter, the present invention is further described in detail in conjunction with accompany drawings, to enable those skilled in the art to practice the invention with reference to the contents of the description.

FIG. 1 shows an implementation according to the present invention, and provides a method for distributing revenue data, including the following steps.

A place in real life for exhibiting a real article is found. The place where the real article is located may be a supermarket, a shopping mall, a subway station, a bus stop, a playing ground of a community, a lobby of a building, or the like. The real article may be a costume, an electrical appliance, food, a toy, a household service, a service of application for a trademark or a patent, a lawyer service, or the like. A master of the place is taken as a first revenue receiving party. For example, in case where the real article is in a supermarket and someone purchases the article, an owner of the supermarket is taken as a first revenue receiving party, and may obtain a part of revenue from the article according a certain rule.

Wherein, the real article is exhibited by a display cabinet having a two-dimensional code thereon. The two-dimensional code is formed with information associated with the article and information associated with the first revenue receiving party. If he or she intends to purchase the real article, a user may scan the two-dimensional code with a terminal such as a mobile phone, an ipad, or the like which is accessible to a network. The two-dimensional code is decoded, and contents in the two-dimensional code is acquired, and then the user terminal is triggered to be associated with the first revenue receiving party and to access an electronic business service platform of the real article for shopping online. The electronic business service platform is presented with introduction and a purchase interface for the real article. The user may see detailed introduction of sizes, material, functions of the article on the platform, choose a color and a size in the purchase interface and fill in delivery time and address after the article is purchase for a direct delivery of the article. The user may also purchase other articles on the electronic business service platform. When the user eventually purchases an article on the electronic business service platform, an operator of the electronic business service platform is taken as a second revenue receiving party, to obtain a part of revenue from the article according a certain rule.

In case where a supplier of the article is the operator of the electronic business service platform, revenue data from the purchased real article is distributed to the first revenue receiving party and the second revenue receiving party. In case where a supplier of the article is a third party who exhibits the article in a place and sells it on the electronic business service platform, revenue data from the purchased real article is distributed to the first revenue receiving party, the second revenue receiving party and the third party according to a previously agreed distributing rule.

If the user does not purchase the article in the display cabinet but purchases other articles on the electronic business service platform after he or she scans the two-dimensional code on the display cabinet, the final revenue data is also distributed to the first revenue receiving party and the second revenue receiving party. If the article purchased by the user is supplied by a third party, the final revenue data is also distributed to the first revenue receiving party, the second revenue receiving party and the third party.

In the present technical solution, the real article is exhibited at various places by display cabinets. The display cabinet is an unattended cabinet which may not be freely opened. The display cabinet is enclosed, and may be opened or closed by an intelligent lock or a mechanical lock. A monitoring device such as a camera may be provided over the display cabinet, to monitor the surroundings, which is safer, smarter, and saving human effort for guarding.

In the present technical solution, the real article exhibited in the display cabinet is the article itself which is to be sold, a model of the article to be sold, an imitation of the article to be sold, or a promotion article of a business service. For example, when selling a toy plane, the toy plane itself which is to be sold, or a 1:1 model of the toy plane, or an imitation of the toy plane which is made of other material, or a picture of the toy plane, or a promotion video of the toy plane may be stored in the display cabinet. Various forms of articles may be arranged in the display cabinet as desired by the merchants.

In the present technical solution, after the user scans the two-dimensional code, the user terminal is associated with the electronic business service platform. In addition to the interface of the article corresponding to the two-dimensional code scanned by the user, the electronic business service platform also records a MAC code of the user terminal to associate the user terminal with the first revenue receiving party. Each revenue data from the real article corresponding to the two-dimensional code or other articles on the electronic business service platform which are subsequently purchased by the user terminal through the electronic business service platform is distributed to the first revenue receiving party. For example, a user is interested in a cup in a display cabinet at a subway station. The user scans a two-dimensional code corresponding to the cup, and then an interface of an electronic business service platform is returned to the user terminal. The user buys the cup on the interface. After he receives the cup, he is very satisfied with the cup, so he directly buys another one on the electronic business service platform. Since at the first time he buys the cup the electronic business service platform has recorded a MAC code of the user terminal to associate the user terminal with the first revenue receiving party, after the second time of payment completed by the user, a part of the revenue data for this time is directly distributed to the first revenue receiving party according to a certain ratio, and the remaining is distributed to the second revenue receiving party and the third party.

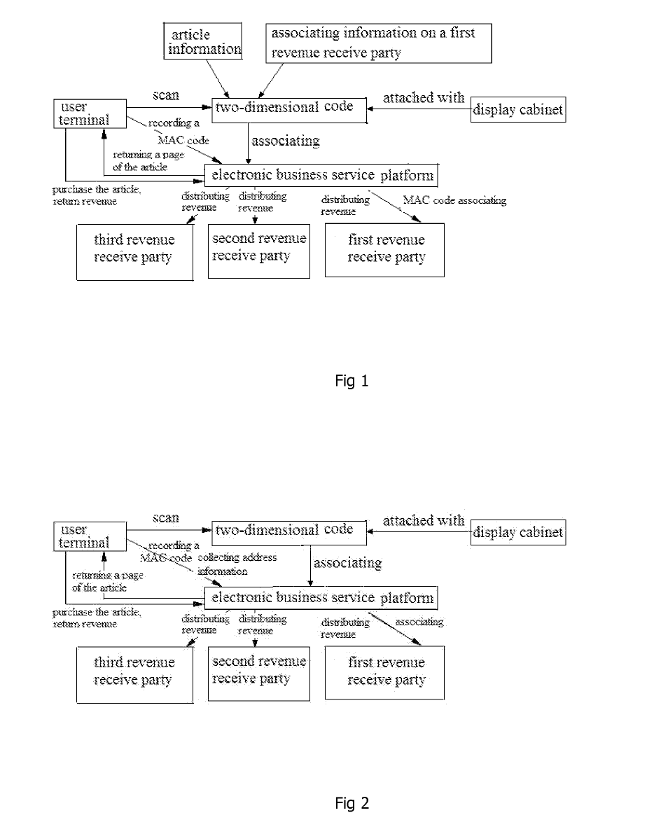

As shown in FIG. 2, in another embodiment, a method for distributing revenue data includes the following steps.

A place in real life for exhibiting a real article is found. The place where the real article is located may be a supermarket, a shopping mall, a subway station, a bus stop, a playing ground of a community, a lobby of a building, or the like. The real article may be a costume, an electrical appliance, food, a toy, a household service, a service of application for a trademark or a patent, a lawyer service, or the like. A master of the place is taken as a first revenue receiving party. For example, in case where the real article is in a supermarket and someone purchases the article, an owner of the supermarket is taken as a first revenue receiving party, and may obtain a part of revenue from the article according a certain rule.

Wherein, the real article is exhibited by a display cabinet having a two-dimensional code thereon. The two-dimensional code is formed with information associated with the article. After a user terminal scans the two-dimensional code, a page of an electronic business service platform of the real article for purchasing the article is returned to the user terminal. In addition, the electronic business service platform is formed with a place list recording relationship between places and addresses. The electronic business service platform searches a corresponding place in the place list through collected address information where the user is located, so as to determine a master of the place and associate the user terminal with the first revenue receiving party, such that a part of revenue data from the purchased article may be distributed to the first revenue receiving party. An electronic business server of the real article may be accessed by scanning the two-dimensional code. The electronic business server is presented with introduction and a purchase interface for the real article. The user may see detailed introduction of sizes, material, functions of the article on the platform, choose a color and a size in the purchase interface and fill in delivery time and address after the article is purchase for a direct delivery of the article. When the user eventually purchases the article on the electronic business service platform, an operator of the electronic business server is taken as a second revenue receiving party, to obtain a part of revenue from the article according a certain rule.

If the user does not purchase the article in the display cabinet but purchases other articles on the electronic business service platform after he or she scans the two-dimensional code on the display cabinet, the final revenue data is also distributed to the first revenue receiving party and the second revenue receiving party. If the article purchased by the user is supplied by a third party, the final revenue data is also distributed to the first revenue receiving party, the second revenue receiving party and the third party.

In case where a supplier of the article is the operator of the electronic business service platform, revenue data from the purchased real article is distributed to the first revenue receiving party and the second revenue receiving party. In case where a supplier of the article is a third party who exhibits the article in a place and sells it on the electronic business service platform, revenue data from the purchased real article is distributed to the first revenue receiving party, the second revenue receiving party and the third party according to a previously agreed distributing rule.

In the present technical solution, after the user scans the two-dimensional code, the user terminal is associated with the electronic business service platform. In addition to the interface of the article corresponding to the two-dimensional code scanned by the user, the electronic business service platform also records a MAC code of the user terminal to associate the user terminal with the first revenue receiving party. Each revenue data from the real article corresponding to the two-dimensional code or other articles displayed on the electronic business service platform which are subsequently purchased by the user terminal through the electronic business service platform is distributed to the first revenue receiving party. For example, a user is interested in a cup in a display cabinet at a subway station. The user scans a two-dimensional code corresponding to the cup, and then an interface of an electronic business service platform is returned to the user terminal. The user buys the cup on the interface. After he receives the cup, he buys a pair of shoes on the electronic business service platform. Since at the first time he buys the cup the electronic business service platform has recorded a MAC code of the user terminal to associate the user terminal with the first revenue receiving party, after the second time of payment completed by the user, a part of the revenue data for this time is directly distributed to the first revenue receiving party according to a certain ratio, and the remaining is distributed to the second revenue receiving party and the third party.

In the present technical solution, the electronic business service platform not only includes articles of the operator, but also of a storekeeper on the electronic business service platform who is taken as a third revenue receiving party. Wherein, revenue data from the purchased real article is distributed to the first revenue receiving party, the second revenue receiving party and the third revenue receiving party according to a preset distributing ratio.

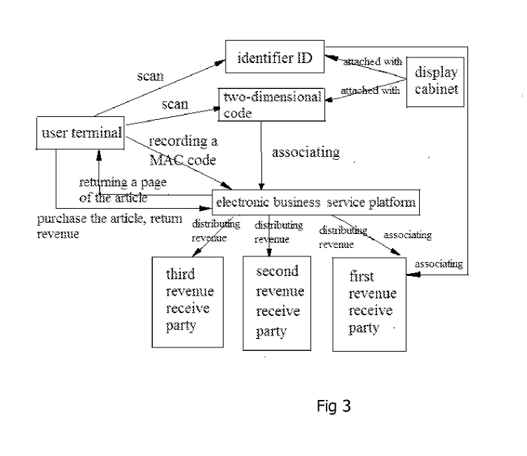

As shown in FIG. 3, in another embodiment, a method for distributing revenue data includes the following steps.

A place in real life for exhibiting a real article is found, and a master of the place is taken as a first revenue receiving party, and the first revenue receiving party having an identifier ID for identifying the first revenue receiving party.

Wherein, the real article is exhibited by a display cabinet having a two-dimensional code thereon. If a user intends to purchase the article, he needs to firstly scan the two-dimensional code and the identifier ID with a terminal. The user terminal scans the identifier ID to associate the user terminal with the first revenue receiving party, such that after the user purchases the real article or other articles on the electronic business service platform, a part of revenue data may be distributed to the first revenue receiving party. The user terminal also scans the two-dimensional code to access the electronic business server of the real article. The electronic business server is presented with introduction and a purchase interface for the real article. The user may see detailed introduction of sizes, material, functions of the article on the platform, choose a color and a size in the purchase interface and fill in delivery time and address after the article is purchase for a direct delivery of the article. When the user eventually purchases the article on the electronic business service platform, an operator of the electronic business server is taken as a second revenue receiving party, to obtain a part of revenue from the article according a certain rule.

In case where a supplier of the article is the operator of the electronic business service platform, revenue data from the purchased real article is distributed to the first revenue receiving party and the second revenue receiving party. In case where a supplier of the article is a third party who exhibits the article in a place and sells it on the electronic business service platform, revenue data from the purchased real article is distributed to the first revenue receiving party, the second revenue receiving party and the third party according to a previously agreed distributing rule.

In the present technical solution, when the user may directly purchase an article he has once purchased on the electronic business service platform, in order to distribute a part of the revenue data from the purchase to the first revenue receiving party, when the user firstly purchases the article at a place, after the user scans the two-dimensional code, the electronic business service platform records a MAC code of the user terminal to associate the user terminal with the first revenue receiving party, such that a part of each revenue data from the real article corresponding to the two-dimensional code or other articles on the electronic business service platform which are subsequently purchased by the user terminal through the electronic business service platform is distributed to the first revenue receiving party.

In the present technical solution, the real article is exhibited by display cabinets, and the real article is locked in the display cabinet. The display cabinet is enclosed, and may be opened or closed by an intelligent lock or a mechanical lock. A monitoring device such as a camera may be provided over the display cabinet, to monitor the surroundings, which is safer, smarter, and saving human effort for guarding. After the two-dimensional code on the display cabinet is scanned, a purchase interface of the article is returned to the terminal on which sizes, usages, colors, outer appearance and ratings from other purchasers are fully presented in a virtual form. The user may also exit from the interface and purchases other articles on the electronic business service platform.

In the present technical solution, the place includes a bus stop, a lobby of a building, an entrance of a restaurant, a shopping mall or a subway channel.

In the present technical solution, the electronic business service platform not only includes articles of the operator, but also of a storekeeper on the electronic business service platform who is taken as a third revenue receiving party. Wherein, revenue data from the purchased real article is distributed to the first revenue receiving party, the second revenue receiving party and the third revenue receiving party.

In the present technical solution, the virtual form comprises: a video, a full-view picture or a picture accompanied by a text, which may display the usage of an article through a video, similar to a method for displaying articles on a Taobao shopping web station; or displays the outer appearance of the article in full view through a full-view picture; or present a text for describing the usage or properties of the article on a picture.

In the present technical solution, the real article includes a service, such as a household service, a service of application for a trademark or a patent, a lawyer service, a house agent, or the like.

Although the embodiments of the present invention have been disclosed as above, they are not limited merely to those set forth in the description and the embodiments, and they may be applied to various fields suitable for the present invention. For those skilled in the art, other modifications may be easily achieved, and the present invention is not limited to the particular details and illustrations shown and described herein, without departing from the general concept defined by the claims and their equivalents.

What is claimed is:

1. A method for distributing revenue data, wherein, the method comprises:
finding a place in real life for exhibiting a real article, and taking a master of the place as a first revenue receiving party;
wherein, the real article is exhibited by a display cabinet having a two-dimensional code thereon which is associated with the first revenue receiving party, an electronic business service platform of the real article is accessible by a user terminal scanning the two-dimensional code, the electronic business service platform is presented with introduction and a purchase interface for the real article, and an operator of the electronic business service platform is taken as a second revenue receiving party;
wherein, revenue data from the purchased real article is distributed to the first revenue receiving party and the second revenue receiving party.

2. The method for distributing revenue data according to claim 1, wherein, the display cabinet is an unattended cabinet which is not freely opened.

3. The method for distributing revenue data according to claim 2, wherein, the real article is the article itself which is to be sold, a model of the article to be sold, an imitation of the article to be sold, or a promotion article of a business service.

4. The method for distributing revenue data according to claim 3, wherein, the method further comprises:
recording a MAC code of the user terminal to associate the user terminal with the first revenue receiving party, and distributing each revenue data from a real article subsequently purchased by the user terminal through the electronic business service platform to the first revenue receiving party.

5. A method for distributing revenue data, wherein, the method comprises:
finding a place in real life for exhibiting a real article, and taking a master of the place as a first revenue receiving party;
wherein, the real article is exhibited by a display cabinet having a two-dimensional code thereon, address information of a place where a user terminal is located is collected by the user terminal scanning the two-dimensional code, a master of the place is determined through the address information, to associated the user terminal and the first revenue receiving party, then an electronic business server of the real article is accessible by the user terminal scanning the two-dimensional code, the electronic business server is presented with introduction and a purchase interface for the real article, and an operator of the electronic business server is taken as a second revenue receiving party;
wherein, revenue data from the purchased real article is distributed to the first revenue receiving party and the second revenue receiving party.

6. The method for distributing revenue data according to claim 5, wherein, associating the user terminal and the first revenue receiving party comprises:
recording a MAC code of the user terminal to associated the MAC code of the user terminal with the first revenue receiving party, and distributing each revenue data from a real article subsequently purchased by the user terminal through the electronic business service platform to the first revenue receiving party.

7. The method for distributing revenue data according to claim 6, wherein, the method further comprises: taking a storekeeper on the electronic business service platform as a third revenue receiving party, wherein, revenue data from the purchased real article is distributed to the first revenue receiving party, the second revenue receiving party and the third revenue receiving party.

8. A method for distributing revenue data, wherein, the method comprises:
finding a place in real life for exhibiting a real article, and taking a master of the place as a first revenue receiving party, and the first revenue receiving party having an identifier ID;
wherein, the real article is exhibited by a display cabinet having a two-dimensional code thereon, a user terminal is associated with the first revenue receiving party by the user terminal scanning the identifier ID, and an electronic business server of the real article is accessible by the user terminal scanning the two-dimensional code, the electronic business server is presented with introduction and a purchase interface for the real article, and an operator of the electronic business server is taken as a second revenue receiving party;
wherein, revenue data from the purchased real article is distributed to the first revenue receiving party and the second revenue receiving party.

9. The method for distributing revenue data according to claim 8, wherein, associating the user terminal and the first revenue receiving party comprises: recording a MAC code of the user terminal to associated the MAC code of the user terminal with the first revenue receiving party, and distributing each revenue data from a real article subsequently purchased by the user terminal through the electronic business service platform to the first revenue receiving party.

10. The method for distributing revenue data according to claim 9, wherein, the real article is locked inside the display cabinet, and the real article is fully presented in a virtual form after a two-dimensional code corresponding to the real article is scanned.

11. The method for distributing revenue data according to claim 10, wherein, the place comprises a bus stop, a lobby of a building, an entrance of a restaurant, a shopping mall or a subway channel.

12. The method for distributing revenue data according to claim 11, wherein, the method further comprises: taking a storekeeper on the electronic business service platform as a third revenue receiving party, wherein, revenue data from the purchased real article is distributed to the first revenue receiving party, the second revenue receiving party and the third revenue receiving party.

13. The method for distributing revenue data according to claim 10, wherein, the virtual form comprises: a video, a full-view picture or a picture accompanied by a text.

14. The method for distributing revenue data according to claim 12, wherein, the real article comprises a service.
